(19) United States
(12) Patent Application Publication
(10) Pub. No.: US 2025/0216151 A1
(43) Pub. Date: Jul. 3, 2025

(54) COMPLEX WAVELENGTH UV LED CONVEYOR SYSTEM

(71) Applicant: UVER CO., LTD., Ansan-si (KR)

(72) Inventor: Yong-Hoon KANG, Ansan-si (KR)

(73) Assignee: UVER CO., LTD., Ansan-si (KR)

(21) Appl. No.: 18/925,577

(22) Filed: Oct. 24, 2024

Related U.S. Application Data
(63) Continuation of application No. PCT/KR2024/012353, filed on Aug. 20, 2024.

(30) Foreign Application Priority Data
Dec. 29, 2023 (KR) 10-2023-0197749

(51) Int. Cl. F26B 3/28; F26B 23/00

(52) U.S. Cl. CPC F26B 3/28; F26B 23/00

(57) ABSTRACT

Provided is an ink curing conveyor including a detachable structure for LED modules to which an ultra-violet light emitting diode (UV-LED) that generates ultraviolet rays having different wavelengths has been applied, an elevation structure of an elevation body for the LED modules, a conveyor including the elevation body, and a controller installed in the conveyor so that the controller is dockable. The wavelengths of UVs that are radiated by the LED modules are different from each other. The detachable structure of the LED module includes a pair of banana plugs and a pair of banana sockets.

### CROSS-REFERENCE TO RELATED APPLICATION

This application is a continuation of International Application No. PCT/KR2024/012353, filed Aug. 20, 2024, which designated the U.S., and also claims the benefit of priority under 35 U.S.C. § 119 (a) of Korean Patent Application No. 10-2023-0197749, filed on Dec. 29, 2023, the contents of both of which are incorporated herein by reference in their entirety.

### BACKGROUND

### 1. Technical Field

The present disclosure relates to an ink curing conveyor including a detachable structure for LED modules to which an ultra-violet light emitting diode (UV-LED) that generates ultraviolet rays having different wavelengths has been applied, an elevation structure of an elevation body for the LED modules, a conveyor including the elevation body, and a controller installed in the conveyor so that the controller is dockable.

### 2. Related Art

In a conventional ink curing tester, only an ultraviolet (UV) LED that generates UVs having a single wavelength can be mounted on an UV curing machine installed on a conveyor. Accordingly, it is inconvenient to replace a UV curing machine itself in order to use a UV curing machine that generates UVs having another wavelength.

Furthermore, the conventional UV curing machine cannot simultaneously radiate UVs having different wavelengths because the conventional UV curing machine has a structure in which only a UV LED that generates UVs having a single wavelength can be mounted. Accordingly, tests relating to the simultaneous use of UVs having various wavelengths which may be combined in order to reduce a process time cannot be performed.

Furthermore, special attention needs to be paid in handling related parts when a damaged LED module is replaced. The training of such a maintenance and repair task is required.

In the conventional ink curing tester, it is inconvenient to loosen and tighten a bolt every time in order to adjust the distance of an LED module to a subject. Furthermore, a controller that controls the LED module needs to be disposed in a separate space because such a height adjustment method of the LED module requires an internal space of the conveyor.

### SUMMARY

Various embodiments are directed to providing an ink curing conveyor capable of testing an optimal UV wavelength combination for reducing a process time because UVs having various wavelengths can be simultaneously used.

Furthermore, various embodiments are directed to providing an ink curing conveyor which enables an untrained user to easily detach an LED module without a need to handle with special care or difficulty.

Furthermore, various embodiments are directed to providing an ink curing conveyor capable of easily adjusting the distance of an LED module to a subject.

Furthermore, various embodiments are directed to providing an ink curing conveyor in which a height adjustment structure for an LED module is disposed on a conveyor and the controller can be docked and embedded in a secured internal space of the conveyor.

Technical objects of the present disclosure are not limited to the above contents that have been explicitly described and may be inferred from the following solving means, and include all of inherent technical objects which may be estimated from effects that may be obtained by the solving of the objects.

In an embodiment, an ink curing conveyor includes a conveyor in which a subject to be radiated may be held in a way to be movable.

The conveyor may include a belt that provides an upper surface on which the conveyor is transferred in a length direction thereof. The subject to be radiated may be transferred in the length direction of the conveyor in the state in which the conveyor has been placed on the upper surface of the belt.

A curing machine that radiates UVs toward the subject to be radiated is installed over the conveyor. The radiation direction of the UVs of the curing machine may be directed downward.

The curing machine includes a UV module that emits and radiates UVs.

The UV module may be installed at the bottom of the curing machine so that the radiation direction of the UVs is directed downward.

The UV module may be provided in plurality.

Preferably, the plurality of UV modules may have mutually corresponding specifications.

A plurality of UV modules is detachably installed at the bottom of the curing machine so that the plurality of UV modules is aligned in parallel in a first direction that intersects the radiation direction of the UVs.

An LED module is embedded in each of the plurality of UV modules.

Preferably, the LED module may have a structure in which a plurality of light sources is installed on a substrate in an array form.

Power connection structures that are electrically connected are provided in the UV module and the curing machine, respectively.

Fastening structures for mutually fastening the UV module and the curing machine are provided in the UV module and the curing machine, respectively.

The fastening structure is provided independently of the power connection structure.

The curing machine is connected to a control device that controls an operation of the LED module.

An elevation device that adjusts the height of the curing machine with respect to the conveyor may be disposed over the conveyor.

The elevation device may include a fixing part fixed to the frame of the conveyor, an elevation part installed in the fixing part so that the elevation part is raised or lowered, and an adjustment part that adjusts the height of the elevation part.

The adjustment part may be installed in the fixing part.

The fixing part may be fixed to frames that are provided on both sides of the belt of the conveyor, respectively.

Preferably, the fixing include a width part may adjustment part that extends in parallel to the width direction of the conveyor and a slider that may slide and move in the length direction of the width adjustment part and that has a bottom fixed to the conveyor. The width adjustment part may have a form of a rail that provides guidance to a movement of the slider.

Preferably, the adjustment part may include a ball screw that extends up and down, a handle that is installed at the top of the ball screw in order to rotate the ball screw, and a locker that is installed at the top of the ball screw in order to prevent the ball screw from being rotated.

A block that is engaged with the ball screw so that the block is raised or lowered while operating in conjunction with the rotation of the ball screw may be provided in the elevation part.

A case in which the curing machine is accommodated in order to restrict a space in which the UVs are radiated by the curing machine may be fixed to the conveyor.

Preferably, the handle and locker of the adjustment part may be exposed upward from the case.

Preferably, an accommodation part may be provided in the conveyor. The accommodation part may be disposed in a space under the belt that provides the transfer surface. The accommodation part may have a form in which the accommodation part is opened to the side of the conveyor.

The control device may include a controller that is accommodated in the accommodation part of the conveyor in a way to be dockable.

The control device may include a control panel having a display touch panel. The display of the control panel may be installed over the conveyor on one side thereof, and may face the side thereof.

The wavelengths of UVs which may be output by the plurality of UV modules may be different from each other. A first wavelength of UVs that are radiated by an LED module embedded in at least any one of the plurality of UV modules may be different from a second wavelength of UVs that are radiated by another of the plurality of UV modules.

The wavelength of the UVs which may be output by the UV module may be included in a range of 255 to 435 nm. The first wavelength and second wavelength of the UVs may be different wavelengths selected among wavelengths of 255 nm, 275 nm, 340 nm, 365 nm, 375 nm, 385 nm, and 395 nm.

In some embodiments, only one UV module can be applied to each of the wavelengths of 255 to 435 nm so that various types of UV wavelengths are output. Furthermore, the number of UV modules for each wavelength may be selected as requested by a user so that an output (or illuminance/quantity of light) for each wavelength of UVs can be optimized. For example, the number of UV modules for the 255 nm wavelength is four, the number of UV modules for the 365 nm wavelength is 1, and the number of UV modules for a 435 nm wavelength is two.

The power connection structure may include a pair of banana plugs that extends downward from the bottom of the curing machine and a pair of banana sockets that is provided in the UV module so that the banana plugs is inserted into the pair of banana sockets, respectively.

A removal groove may be provided at the top of the UV module at an end thereof in a second direction that intersects both the first direction and the radiation direction.

An alignment protrusion may be provided on one side of each UV module in the first direction.

An alignment groove having a shape complementary to the shape of the alignment protrusion may be provided on the other side of the UV module in the first direction, which faces the alignment protrusion.

The fastening structure may include a first fastening hole that is provided in the alignment protrusion at an end of the UV module on one side thereof in the first direction and a second fastening hole that is provided at an end of the UV module on the other side thereof in the first direction and that is disposed at a location out of the alignment groove.

The fastening structure may include a third fastening hole and a fourth fastening hole that are provided at the bottom of the curing machine so that the third fastening hole and the fourth fastening hole correspond to the locations of the first fastening hole and the second fastening hole, respectively.

The UV module may include a first optical sensor that detects the intensity of UVs. The direction in which the first optical sensor receives light may be parallel to the direction in which the light source radiates UVs.

Preferably, the first optical sensor may be mounted on the substrate of the LED module.

The conveyor may include a second optical sensor that detects the intensity of UVs.

Preferably, the second optical sensor may be installed in guides that are provided on both sides thereof in the width direction of the belt so that the guides provide guidance to a movement of the belt. The second optical sensor may be installed in plurality in the length direction of the guide.

According to an embodiment of the present disclosure, the ink curing conveyor can simultaneously use UVs having various wavelengths in order to find an optimal UV wavelength combination for reducing a process time because the ink curing conveyor has compatibility which enables LED modules that emit UVs having different wavelengths to be installed. Furthermore, there is no inconvenience in replacing an LED module whenever UV radiation tests using different wavelengths are performed.

According to an embodiment of the present disclosure, even an untrained and inexperienced user can attach and detach an LED module without difficulty. A power connection to and power connection release from an LED module are certainly performed when the LED module is attached and detached.

According to an embodiment of the present disclosure, it is possible to easily adjust the distance of an LED module to a subject and to finely adjust the distance without difficulty.

According to an embodiment of the present disclosure, the height of an LED module can be conveniently adjusted because the height adjustment structure for the LED module is disposed on the conveyor that is easily accessed. Accordingly, the controller can be docked and embedded in a secured internal space of the conveyor.

Detailed effects of the present disclosure along with the aforementioned effects are described hereinafter while describing detailed contents for implementing the present disclosure.

### BRIEF DESCRIPTION OF THE DRAWINGS

FIG. 1 is a perspective view of an ink curing conveyor according to an embodiment.

FIG. 2 is a perspective view illustrating the state in which a controller has been detached from an accommodation part of a conveyor illustrated in FIG. 1.

FIG. 3 is a perspective view illustrating the state in which the door of the case of a curing machine has been opened.

FIG. 4 is a perspective view illustrating the state in which the controller and the case have been omitted in FIG. 3.

FIG. 5 is a perspective view illustrating the elevation device and elevation part of the curing machine illustrated in FIG. 4.

FIGS. 6 and 7 are side views illustrating that the elevation part is raised and lowered by the elevation device of FIG. 5.

FIGS. 8 and 9 are an upper perspective view and lower perspective view of the elevation part of each curing machine.

FIG. 10 illustrates the state in which one LED module has been detached from an elevation body illustrated in FIG. 9.

FIG. 11 is a dismantled perspective view of the LED module illustrated in FIG. 10.

FIG. 12 is a lateral cross-sectional view illustrating a banana socket part of the LED module illustrated in FIG. 10.

FIG. 13 is a lateral cross-sectional view illustrating the state in which the banana socket part of the LED module illustrated in FIG. 10 and the banana plug of the elevation body have been combined.

FIG. 14 is a bottom view of the elevation body.

FIG. 15 is a plan view of the ink curing conveyor from which the case and a control panel have been omitted.

FIG. 16 illustrates a general system control screen of the control panel.

FIG. 17 illustrates an LED part control screen of the control panel.

FIG. 18 illustrates an optical sensor monitoring screen of the control panel.

FIG. 19 illustrates an access monitoring screen of the control panel.

### DESCRIPTION OF REFERENCE NUMERALS

10: conveyor 12: accommodation part 13: second optical sensor 20: controller 30: curing machine 40: case 41: door 50: elevation device 51: fixing part 52: locker (adjustment part) 53: handle (adjustment part) 54: ball screw (adjustment part) 55: width adjustment part 56: slider 60: elevation part 61: elevation body 62: banana plug 63: third fastening hole 64: fourth fastening hole 65: block 70: UV module 71: module body 72: alignment protrusion 721: first fastening hole 73: alignment groove 731: second fastening hole 74: LED module 741: light source 742: first optical sensor 75: banana socket 76: nut 77: window 78: removal groove 80: control panel

### DETAILED DESCRIPTION

Hereinafter, embodiments of the present disclosure are described in detail with reference to the accompanying drawings.

The present disclosure is not limited to the embodiments disclosed hereinafter, and may be variously changed and may be implemented in various different forms. The embodiments are merely provided to complete the present disclosure and to fully notify a person having ordinary knowledge in the art to which the present disclosure pertains of the category of the present disclosure. Accordingly, it is to be understood that the present disclosure is limited to embodiments disclosed hereinafter and that the present disclosure includes all changes, equivalents, and substitutions which fall within the technical spirit and scope of the present disclosure in addition to the substitution or addition of a component in any one embodiment with or to a component in another embodiment.

It is to be understood that the accompanying drawings are merely intended to help easily understood the embodiments disclosed in this specification, and the technical spirit disclosed in this specification is not restricted by the accompanying drawings and includes all changes, equivalents, and substitutions which fall within the spirit and technical scope of the present disclosure. In the drawings, the size or thickness of each of components may be exaggerated and expressed largely or small by considering convenience of understanding, etc., but the right of scope of the present disclosure should not be construed as being limited accordingly.

The terms used in this specification are merely used to describe a specific implementation example or embodiment, and are not intended to limit the present disclosure. Furthermore, an expression of the singular number includes an expression of the plural number unless clearly defined otherwise in the context. In the specification, a term, such as “include” or “consist of”, is intended to designate that a characteristic, a number, a step, an operation, a component, a part of a combination of them described in the specification is present. That is, it is to be understood that the term, such as “include” or “consist of”, in the specification does not exclude the presence or addition possibility of one or more other characteristics, numbers, steps, operations, components, parts, or combinations of them in advance.

Terms including ordinal numbers, such as a “first” and a “second”, may be used to describe various components, but the components are not limited by the terms. The terms are used to only distinguish one component from the other components.

When it is said that one component is “connected” or “coupled” to another component, it should be understood that one component may be directly connected or coupled to another component, but a third component may exist between the two components. In contrast, when it is described that one component is “directly connected” or “directly coupled to” the other component, it should be understood that a third component does not exist between the two components.

It should be understood that when it is described that one component is disposed “over” or “under” the other component, the one component may be disposed right over the other component or another component may be disposed between the two components.

All terms used herein, including technical or scientific terms, have the same meanings as those commonly understood by a person having ordinary knowledge in the art to which an embodiment pertains, unless defined otherwise in the specification. Terms, such as those defined in commonly used dictionaries, should be construed as having the same meanings as those in the context of a related technology, and are not construed as having ideal or excessively formal meanings unless explicitly defined otherwise in the specification.

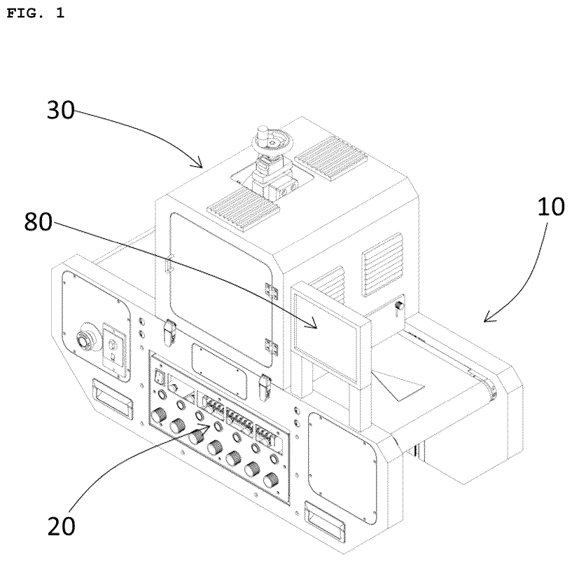

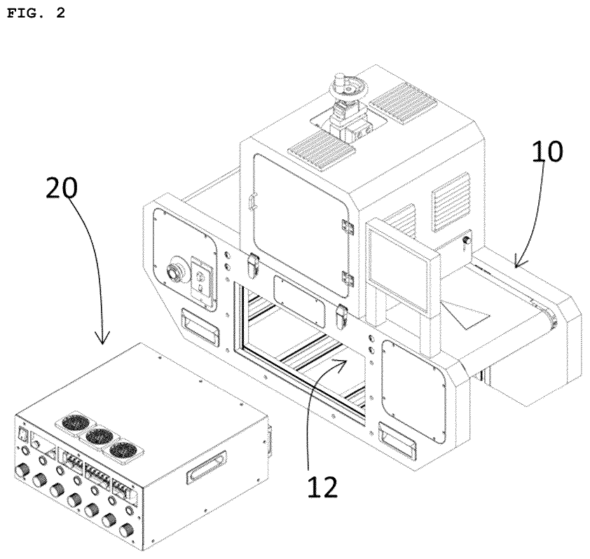

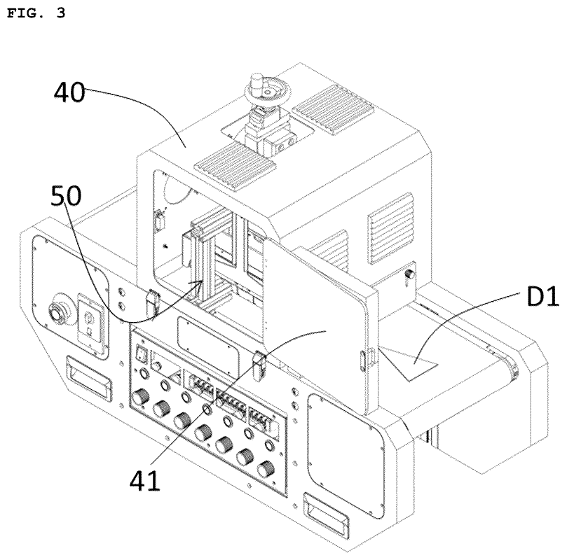

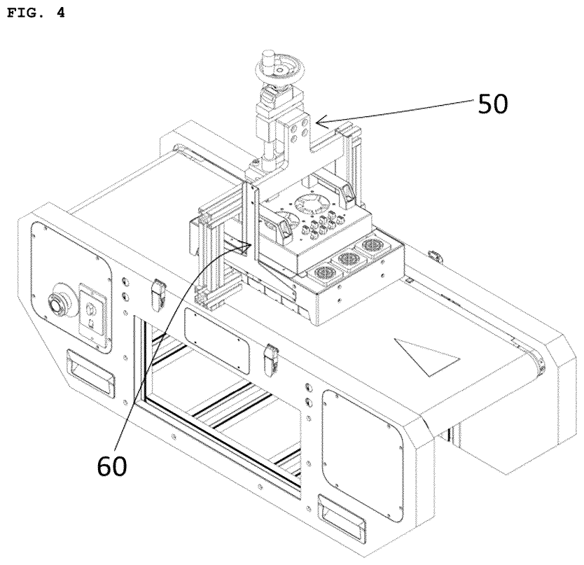

Referring to FIGS. 1 to 4, an ink curing conveyor according to an embodiment includes a conveyor 10 in which a subject to be radiated is held so that the subject can be moved in a first direction D1. A curing machine 30 that radiates ultraviolet rays (UVs) toward the subject to be radiated is installed on the conveyor 10. The radiation direction of the UVs is directed downward. That is, the curing machine 30 downward radiates the UVs.

A case 40 that accommodates the curing machine 30 in order to restrict the radiation space of UVs that are radiated by the curing machine 30 is fixed to the conveyor 10. A door 41 is installed in front of the case 40 so that a user can access the curing machine 30 in front of the conveyor 10.

The curing machine 30 is electrically connected to a controller 20 that controls an operation of an LED module 74. The conveyor 10 is equipped with an accommodation part 12 in which the controller 20 is accommodated in a way to be dockable. Accordingly, the controller 20 can be installed without inconvenience for preparing a space in which the controller 20 is separately disposed. The controller 20 may also control an operation of the conveyor 10 in addition to the curing machine 30.

A control panel 80 to which an input is possible through a display touch panel is installed over the conveyor 10 in front thereof. The control panel 80 may control the curing machine 30 and the conveyor 10 independently of the controller 20 or while operating in conjunction with the controller 20.

An elevation device 50 that adjusts the height of the curing machine 30 with respect to the conveyor 10 is disposed over the conveyor 10.

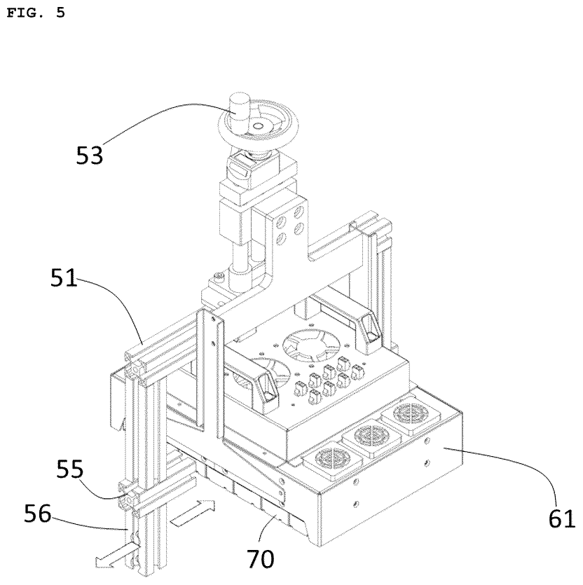

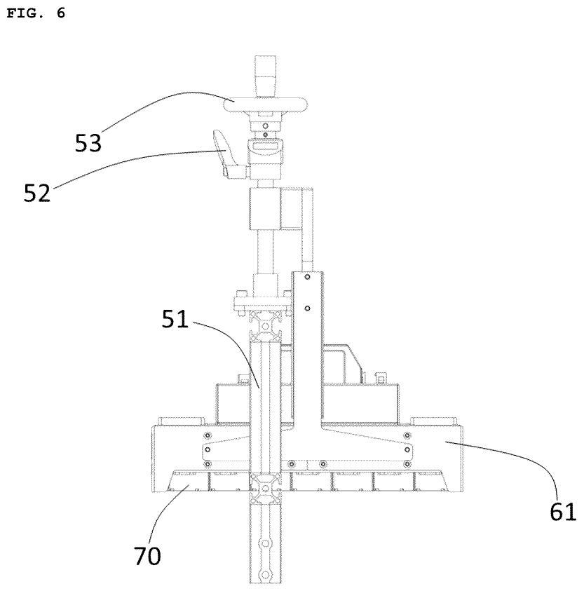

Referring to FIGS. 5 to 7, the elevation device 50 includes a fixing part 51 fixed to the frame of the conveyor 10, an elevation part 60 installed in the fixing part 51 in a way to be raised or lowered, and an adjustment part 52, 53, and 54 that adjusts the height of the elevation part 60.

The adjustment part 52, 53, and 54 is installed in the fixing part 51.

The adjustment part 52, 53, and 54 includes a ball screw 54 that extends up and down, a handle 53 installed at the top of the ball screw in order to rotate the ball screw, and a locker 52 installed at the top of the ball screw in order to prevent the rotation of the ball screw.

The elevation part 60 is equipped with a block 65 that is engaged with the ball screw so that the elevation part 60 is raised and lowered while operating in conjunction with the rotation of the ball screw.

The curing machine 30 includes an elevation body 61 that is connected to the elevation part 60. A plurality of UV modules 70 is installed at the bottom of the elevation body 61.

As illustrated in FIGS. 1 to 3, the handle 53 and locker 52 of the adjustment part 52, 53, and 54 are exposed over the case 40. A part of an upper part of the case 40 is opened because the curing machine 30 downward radiates UVs. Accordingly, there is no concern that UVs will leak through the handle 53 and the locker 52 although the handle 53 and the locker 52 are exposed.

When a user releases the locker 52 and then turns the handle 53 to one side thereof, the curing machine 30 is raised. When a user turns the handle 53 to the other side thereof, the curing machine 30 is lowered. When a user locks the locker 52, the handle 53 is not rotated and thus the height of the curing machine 30 is fixed.

According to an embodiment, there can be provided the space in which the controller 20 is dockable within the conveyor 10 because the elevation device 50 is disposed over the conveyor 10.

The width of the fixing part 51 may be adjusted so that the fixing part 51 can be installed in various conveyors 10 having different widths. Referring to FIG. 5, the fixing part 51 includes a width adjustment part 55 that has a rail form and that extends in parallel to the width direction of the conveyor 10. A slider 56 having a fixing portion which may be fixed to the conveyor 10 is connected to the width adjustment part 55 in a way to slide and move. The slider 56 may not slide and move with respect to the width adjustment part 55 if the slider 56 is fixed to the width adjustment part 55 after the location of the slider 56 is adjusted.

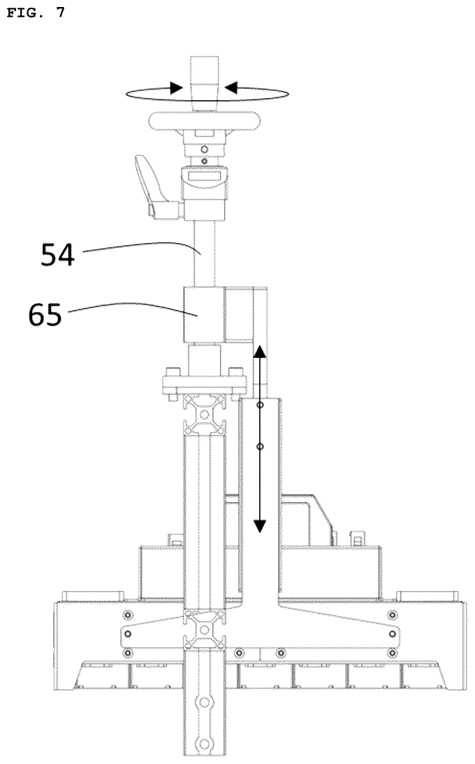

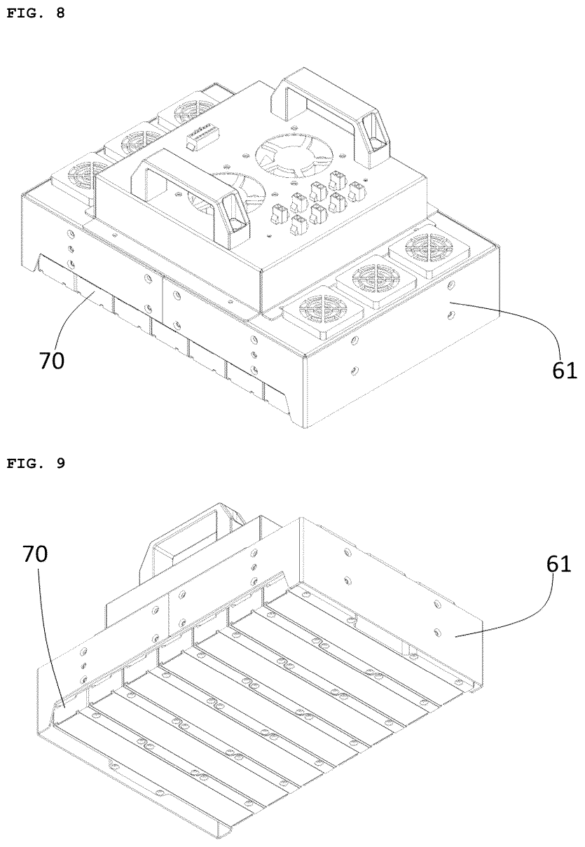

Referring to FIGS. 8 to 11, the plurality of UV modules 70 is aligned in parallel in the first direction D1, and is detachably installed at the bottom of the curing machine 30. Each of the plurality of UV modules 70 includes a module body 71 in which the LED module 74 is embedded.

An alignment protrusion 72 is provided on one side of the module body 71 of each UV module 70 in the first direction. Furthermore, an alignment groove 73 having a shape complementary to that of the alignment protrusion 72 is provided on the other side of the module body 71 that faces the alignment protrusion 72 in the first direction. Accordingly, the UV modules 70 can be easily aligned in the first direction, and an error in connecting polarities in reverse in a process of connecting to the power source of the LED module 74 from which DC power is supplied can be prevented. An embodiment of the present disclosure illustrates that a shape of each of the alignment protrusion 72 and the alignment groove 73 is an isosceles trapezoid.

A first wavelength of UVs that are radiated by the LED module 74 embedded in any one of the plurality of UV modules 70 is different from a second wavelength of UVs that are radiated by the LED module 74 embedded in another of the plurality of UV modules 70.

The first wavelength and second wavelength of the UVs may be different wavelengths selected among wavelengths 255 nm, 275 nm, 340 nm, 365 nm, 375 nm, 385 nm, and 395 nm.

A window 77 through which UVs emitted by the LED module 74 can pass is installed at the bottom of the UV module 70. The material of the window 77 may be quartz or monomer PMMA, for example. Accordingly, a user's hand can be prevented from coming into contact with an element or lens of the LED module 74 by mistake.

According to an embodiment, the plurality of UV modules 70 has the same external dimension specifications, but the wavelengths of UVs that are radiated by the plurality of LED modules 74 within the plurality of UV modules 70 are different. Accordingly, the plurality of UV modules 70 that generate UVs having different wavelengths may be installed at arbitrary locations of the bottom of the curing machine 30.

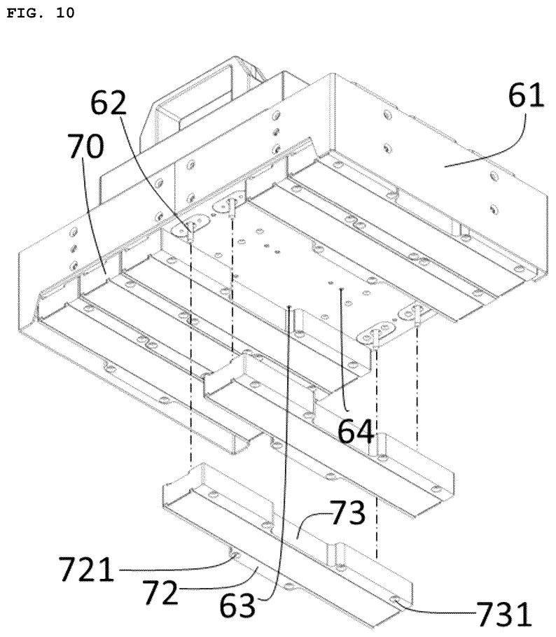

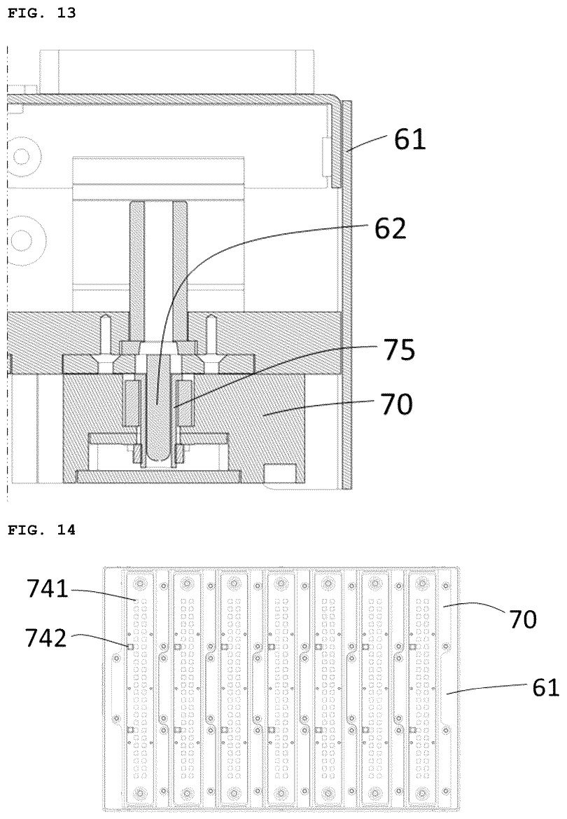

Referring to FIGS. 10 to 13, power connection structures that are mutually connected are provided at the UV module 70 and the curing machine 30, respectively.

The power connection structure includes a pair of banana plugs 62 that downward extends from the bottom of the curing machine 30 and a pair of banana sockets 75 provided in the UV module 70 so that the pair of banana plugs 62 is inserted into the pair of banana sockets 75, respectively.

The pair of banana plugs 62 and the pair of banana sockets 75 provide a temporary fastening force that restricts the pair of banana plugs 62 and the pair of banana sockets 75 from being relatively moved in a length direction thereof when the pair of banana plugs 62 and the pair of banana sockets 75 are mutually coupled in the length direction. Accordingly, a user can further easily perform a task for fastening the UV module 70 to the bottom of the curing machine 30.

A space in which the LED module 74 is accommodated is provided under the module body 71 of the UV module 70. The banana socket 75 downward extends through the module body 71 and the LED module 74 from the top of the module body 71, and is fastened to a nut 76 under the LED module 74. Accordingly, the LED module 74 is closely fixed to the module body 71, and the directions in which the fastening holes of the pair of banana sockets 75 are opened are aligned upward. The module body 71 may be fabricated by using a material having high thermal conductivity so that heat that is generated from the LED module 74 can be rapidly discharged.

A removal groove 78 is provided at the top of the UV module 70 at an end thereof in the second direction that intersects both the first direction and the radiation direction. The removal groove 78 helps a user to easily remove the UV module 70 from the elevation body 61 of the curing machine 30 even through the temporary fastening force.

Referring to FIG. 10, the UV module 70 and the curing machine 30 are provided with fastening structures for mutually fastening the UV module 70 and the curing machine 30.

The fastening structure is provided independently of the power connection structure.

The fastening structure includes a first fastening hole 721 that is provided in alignment protrusion 72 at an end of the module body 71 on one side thereof in the first direction and a second fastening hole 731 that is provided at an end of the module body 71 on the other side thereof in the first direction and that is disposed at a location out of the alignment groove 73.

Accordingly, the fastening structure includes a third fastening hole 63 and a fourth fastening hole 64 that are provided at the bottom of the curing machine 30 so that the third fastening hole 63 and the fourth fastening hole 64 correspond to the locations of the first fastening hole 721 and the second fastening hole 731, respectively. The locations of the first fastening hole 721 and the third fastening hole 63 are disposed to deviate from the locations of the second fastening hole 731 and the fourth fastening hole 64 in the second direction. Accordingly, there is no concern that the directions in which the plurality of UV modules 70 is fastened are aligned in reverse.

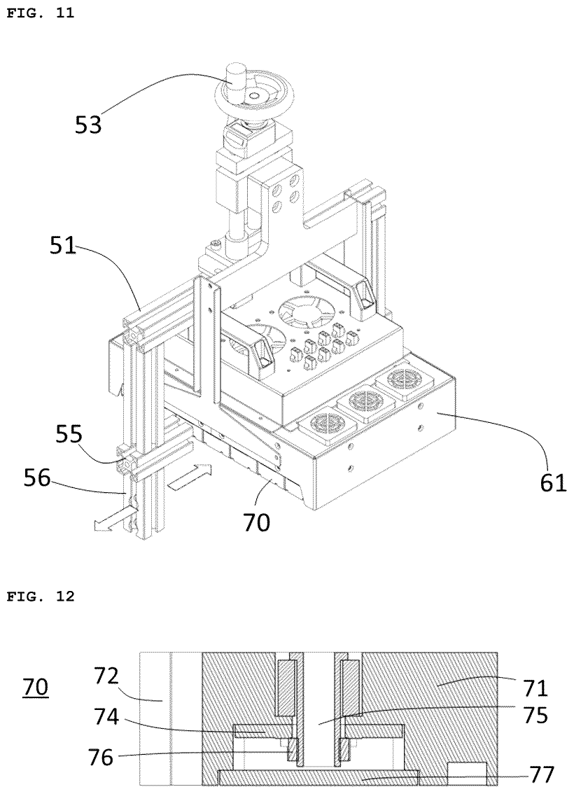

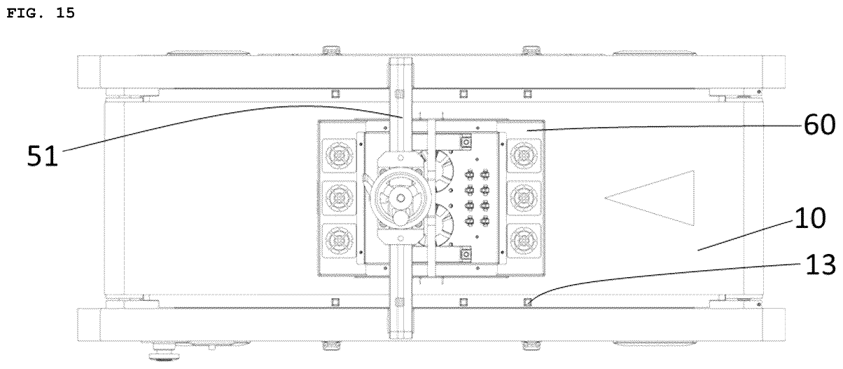

Referring to FIGS. 11, 14, and 15, a first optical sensor 742 and a second optical sensor 13 are installed in the curing machine 30 and the conveyor 10, respectively. The first optical sensor 742 is installed in each LED module 74 along with an LED light source 741 that emits UVs. The direction in which the first optical sensor 742 receives light is parallel to the direction in which the light source 741 emits light. The second optical sensor 13 is installed at a guide portion that provides guidance to a movement of the belt of the conveyor 10 on both sides of the belt. The direction in which the first optical sensor 742 receives light may be directed downward. The direction in which the second optical sensor 13 receives light may be directed upward.

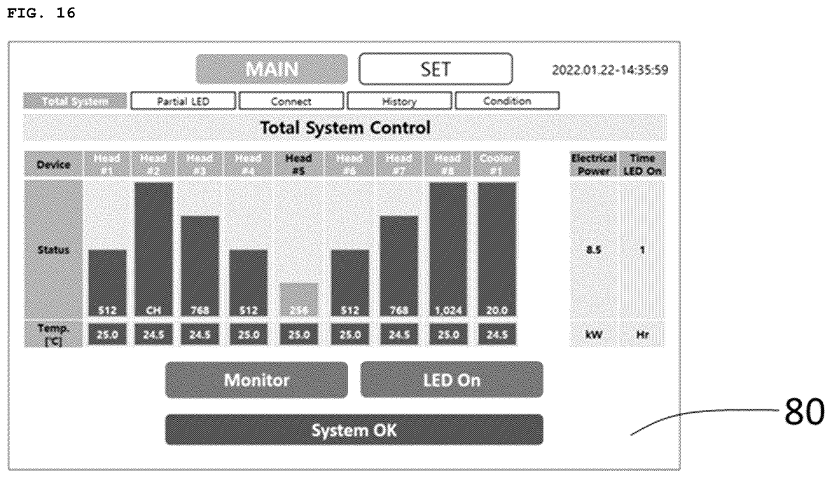

Referring to FIGS. 16 to 19, the control panel 80 displays a screen which may be controlled through a display. Furthermore, a user may control each function by touching a touch panel, and may monitor an operation state of the curing machine 30.

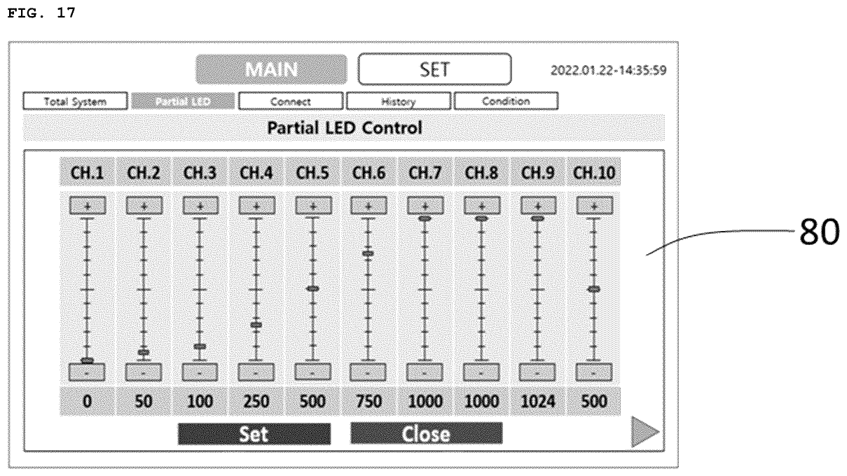

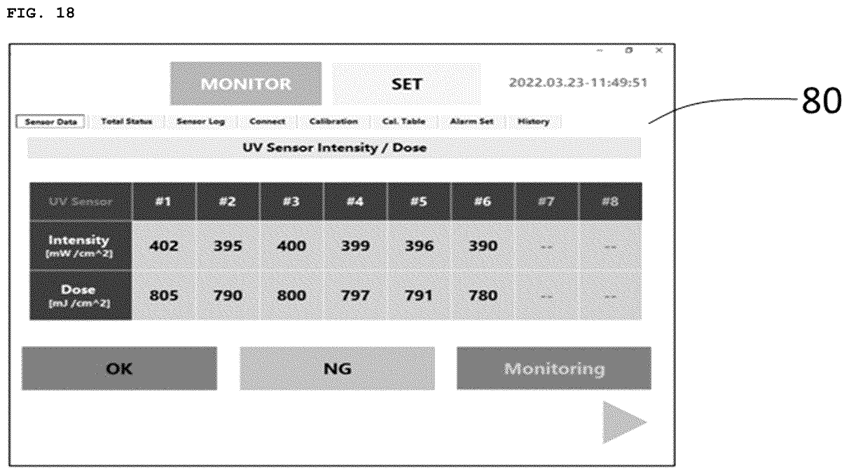

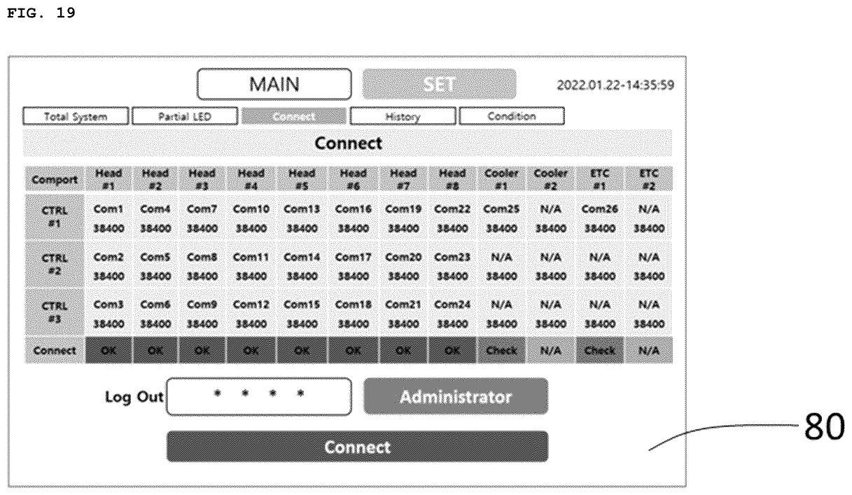

Referring to FIG. 16, the control panel 80 may display the quantity of light and a temperature for each channel of each LED module 74, and may display the state of a cooling device. In addition, the control panel 80 may display power used and an operation time of the LED light source 741. As illustrated in FIG. 17, the control panel 80 may provide a control screen on which the quantity of light of the LED module 74 of each channel can be adjusted. Furthermore, as illustrated in FIG. 18, the control panel 80 may measure the intensity of UVs and the quantity of radiation which are measured by the optical sensors 742 and 13. As illustrated in FIG. 19, a user can monitor the state of each channel through the control panel 80.

For the purpose of the aforementioned embodiments, it is obvious that various modifications may be made and that a person skilled in the art who understands the embodiments may easily perform such modifications.

Although the present disclosure has been described with reference to the illustrated drawings as described above, it is evident that the present disclosure is not restricted by the embodiments and drawings disclosed in this specification and may be modified in various ways by those skilled in the art without departing from the technical spirit of the present disclosure. Although acting effects according to the constructions of the present disclosure have not been explicitly described while the embodiments of the present disclosure are described, effects which may be predicted by a corresponding construction should also be recognized.

What is claimed is:

1. An ink curing conveyor comprising:
a conveyor in which a subject to be radiated is held in a way to be movable;
a curing machine installed over the conveyor so that the curing machine radiates ultraviolet rays (UVs) toward the subject to be radiated;
a plurality of UV modules (aligned in parallel in a first direction that intersects a radiation direction of the UVs and installed at a bottom of the curing machine in a way to be detachable;
an LED module embedded in each of the plurality of UV modules;
a power connection structure provided in each of the UV module and the curing machine;
a fastening structure provided in each of the UV module and the curing machine independently of the power connection structure; and
a control device connected to the curing machine and configured to control an operation of the LED module.

2. The ink curing conveyor of claim 1, further comprising an elevation device disposed over the conveyor and configured to adjust a height of the curing machine with respect to the conveyor.

3. The ink curing conveyor of claim 2, wherein the elevation device comprises:
a fixing part fixed to a frame of the conveyor;
an elevation part installed in the fixing part so that the elevation part is raised or lowered; and
an adjustment part installed in the fixing part and configured to adjust a height of the elevation part.

4. The ink curing conveyor of claim 3, wherein the fixing part comprises:
a width adjustment part that extends in parallel to a width direction of the conveyor, and
a slider that is able to slide and move in a length direction of the width adjustment part and that has a bottom fixed to the conveyor.

5. The ink curing conveyor of claim 3, wherein the adjustment part comprises:
a ball screw that extends up and down;
a handle installed at a top of the ball screw in order to rotate the ball screw;
a locker installed at the top of the ball screw in order to prevent the ball screw from being rotated; and
a block provided in the elevation part and raised and lowered while operating in conjunction with the rotation of the ball screw by being engaged with the ball screw.

6. The ink curing conveyor of claim 3, further comprising a case that is fixed to the conveyor and that restricts a space in which the UVs are radiated by the curing machine by accommodating the curing machine,
wherein at least a part of the adjustment part is exposed upward from the case.

7. The ink curing conveyor of claim 2, wherein the control device comprises a controller that is accommodated in an accommodation part of the conveyor in a way to be dockable.

8. The ink curing conveyor of claim 1, wherein the control device comprises a control panel having a display touch panel.

9. The ink curing conveyor of claim 1, wherein a first wavelength of UVs that are radiated by the LED module embedded in at least any one of the plurality of UV modules is different from a second wavelength of UVs that are radiated by the LED module embedded in another of the plurality of UV modules.

10. The ink curing conveyor of claim 9, wherein the first wavelength and second wavelength of the UVs are different wavelengths selected among wavelengths of 255 nm, 275 nm, 340 nm, 365 nm, 375 nm, 385 nm, and 395 nm.

11. The ink curing conveyor of claim 1, wherein the power connection structure comprises:
a pair of banana plugs extended downward from the bottom of the curing machine; and
a pair of banana sockets provided in the UV module so that the pair of banana plugs is inserted into the pair of banana sockets.

12. The ink curing conveyor of claim 11, wherein the UV module comprises a removal groove that is provided at a top of the UV module at an end thereof in a second direction that intersects both the first direction and the radiation direction.

13. The ink curing conveyor of claim 1, wherein each UV module comprises:
an alignment protrusion provided on one side of the UV module in the first direction; and
an alignment groove provided on the other side of the UV module in the first direction so that the alignment groove faces the alignment protrusion and having a shape complementary to a shape of the alignment protrusion.

14. The ink curing conveyor of claim 13, wherein the fastening structure comprises:
a first fastening hole provided in the alignment protrusion at an end of the UV module on one side thereof in the first direction;
a second fastening hole that is provided at an end of the UV module on the other side thereof in the first direction and that is disposed at a location out of the alignment groove; and
a third fastening hole and a fourth fastening hole provided at locations corresponding to the first fastening hole and the second fastening hole, respectively, at the bottom of the curing machine.

15. The ink curing conveyor of claim 1, wherein the UV module comprises a first optical sensor that detects an intensity of the UVs.

16. The ink curing conveyor of claim 1, wherein a plurality of second optical sensors that is disposed in a length direction of the conveyor and that detects an intensity of the UVs is installed on both sides of the conveyor.
